(19) United States
(12) Patent Application Publication
(10) Pub. No.: US 2021/0063968 A1
(43) Pub. Date: Mar. 4, 2021

(54) WATCH COMPONENT AND WATCH

(71) Applicant: Seiko Epson Corporation, Tokyo (JP)

(72) Inventor: Daiki FURUSATO, Ina (JP)

(21) Appl. No.: 17/004,088

(22) Filed: Aug. 27, 2020

(30) Foreign Application Priority Data
Aug. 28, 2019 (JP) 2019-155536

(51) Int. Cl. G04B 19/04; G02B 5/00; G02B 5/28

(52) U.S. Cl. CPC G04B 19/04; G04B 19/042; G02B 5/285; G02B 5/003

(57) ABSTRACT

A watch component includes a base material, and a decorative film including a color absorption film and a color adjustment film, an arithmetic mean roughness Ra of a surface, on which the decorative film is disposed, of the base materialis equal to or greater than 0.02 μm and equal to or less than 0.1 μm, a film thickness of the decorative film is equal to or greater than 0.25 μm and equal to or less than 1.0 μm, and a ratio of the film thickness of the decorative film to the arithmetic mean roughness Ra of the surface is equal to or greater than 2.5 and equal to or less than 25.

### BACKGROUND

The present application is based on, and claims priority from JP Application Serial Number 2019-155536, filed Aug. 28, 2019, the disclosure of which is hereby incorporated by reference herein in its entirety.

### 1. Technical Field

The present disclosure relates to a watch component and a watch.

### 2. Related Art

JP-A-2018-124267 discloses a watch component including a color adjustment film that adjusts a color tone laminated on a substrate being a metallic glossy portion.

In the watch component in JP-A-2018-124267, excellent aesthetics can be achieved even without using a noble metal as a main material by adjusting a color tone of an appearance by the metallic glossy portion and the color adjustment film.

JP-A-2018-124267 discloses that the metallic glossy portion is constituted by a material containing nitride, carbide, or a metal material, and the color adjustment film is constituted by a material including at least one type selected from a group of a metal oxide film and an inorganic oxide film, but no reference is made to roughness of a surface. Thus, in the watch component in JP-A-2018-124267, there is a problem in that a shine is excessive, that is, glare is too strong, and thus a sense of luxury is less likely to be acquired.

### SUMMARY

A watch component of the present disclosure includes a base material, and a decorative film including a color absorption film and a color adjustment film, an arithmetic mean roughness Ra of a surface, on which the decorative film is disposed, of the base material is equal to or greater than 0.02 μm and equal to or less than 0.1 μm, a film thickness of the decorative film is equal to or greater than 0.25 μm and equal to or less than 1.0 μm, and a ratio of the film thickness of the decorative film to the arithmetic mean roughness Ra of the surface is equal to or greater than 2.5 and equal to or less than 25.

In the watch component of the present disclosure, the color absorption film and the color adjustment film may be laminated in this order on the surface.

The watch component of the present disclosure may include an adhesive layer disposed between the decorative film and the surface.

In the watch component of the present disclosure, a material of the base material may be metal, resin, or glass.

In the watch component of the present disclosure, the color absorption film may be constituted of a film containing nitride, carbide, or metal.

In the watch component of the present disclosure, the nitride may be TiN or CrN, the carbide may be TiC or CrC, and the metal may be Ag, Pt, Au, Cu, Al, Cr, Sn, Fe, Ti, or an alloy thereof.

In the watch component of the present disclosure, the color adjustment film may be constituted of a multilayer film including an inorganic oxide film.

In the watch component of the present disclosure, the multilayer film may include two or more oxide layers constituted of a material including at least one type selected from a group consisting of Ta₂O₅, SiO₂, TiO₂, Al₂O₃, ZrO₂, Nb₂O₅, and HfO₂.

A watch of the present disclosure includes the watch component.

### BRIEF DESCRIPTION OF THE DRAWINGS

FIG. 1 is a front view illustrating a watch according to a first exemplary embodiment.

FIG. 2 is an enlarged cross-sectional view illustrating a main part of a hand according to the first exemplary embodiment.

FIG. 3 is an enlarged cross-sectional view illustrating a main part of a hand according to a second exemplary embodiment.

### DESCRIPTION OF EXEMPLARY EMBODIMENTS

First Exemplary Embodiment

A watch 1 according to a first exemplary embodiment of the present disclosure will be described below with reference to the drawings.

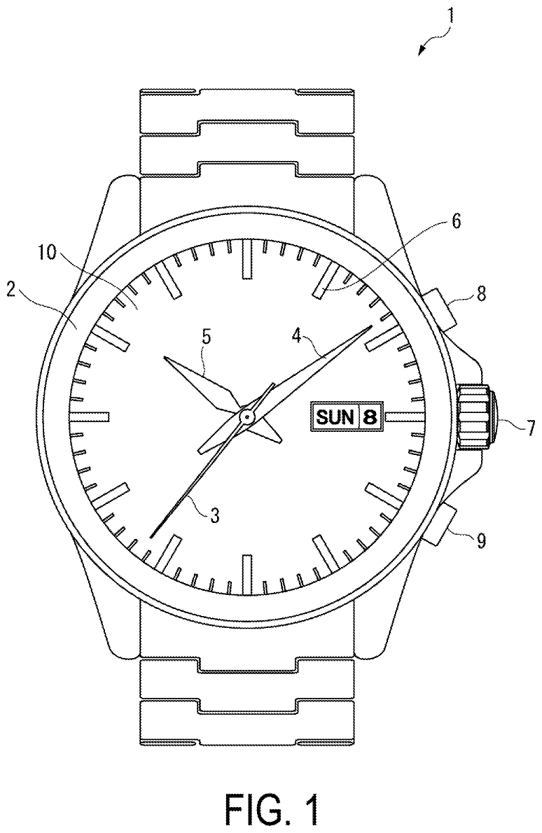

FIG. 1 is a front view illustrating the watch 1. In the present exemplary embodiment, the watch 1 is constituted as a wrist watch worn on a wrist of a user.

As illustrated in FIG. 1, the watch 1 includes a case 2 made of metal. In addition, the case 2 includes a disk-shaped dial 10, a seconds hand 3, a minute hand 4, an hour hand 5, a crown 7, an A button 8, and a B button 9 therein. Note that the hour hand 5 is one example of a watch component of the present disclosure.

The dial 10 is provided with an hour mark 6 for indicating a time.

Hour Hand

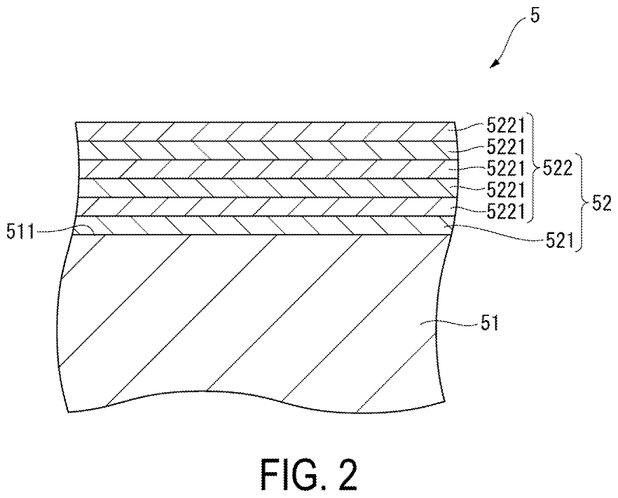

FIG. 2 is an enlarged cross-sectional view of a main part of the hour hand 5. Note that FIG. 2 illustrates a cross-sectional view of the hour hand 5 cut in a depth direction.

The hour hand 5 includes a base material 51 and a decorative film 52. Note that, in the present exemplary embodiment, the entire base material 51 is covered with the decorative film 52. In other words, the decorative film 52 is disposed so as to cover an entire surface 511 of the base material 51.

Base Material

A material for the base material 51 is made of metal, such as iron, brass, and aluminum, resin, glass, or the like. Note that, when the base material 51 is made of resin, the resin may be a non-transparent resin that does not transmit light, or may be a transparent resin that transmits light. Then, the surface 511 of the base material 51 is surface-treated such that an arithmetic mean roughness Ra is equal to or greater than 0.02 μm and equal to or less than 0.1 μm. A method of surface treatment is not particularly limited, and examples thereof include wet blasting, micro blasting, electro-polishing, rubbing treatment, and the like. Note that the arithmetic mean roughness Ra in the present exemplary embodiment conforms to “JIS B 0601”.

Decorative Film

The decorative film 52 includes a color absorption film 521 and a color adjustment film 522, and is disposed on the surface 511 side of the base material 51. Then, a film thickness of the decorative film 52 is equal to or greater than 0.25 μm and equal to or less than 1.0 μm. The reason is that there is a risk that a degree of flexibility in color adjustment may decrease when a film thickness of the decorative film 52 is thinner than 0.25 μm, and the base material 51 may deform due to film stress when a film thickness of the decorative film 52 is thicker than 1.0 μm. Note that a film thickness of the decorative film 52 is more preferably equal to or greater than 0.3 μm and equal to or less than 0.5 μm.

Here, in the present exemplary embodiment, the base material 51 and the decorative film 52 are formed such that a ratio (film thickness/Ra) of a film thickness of the decorative film 52 to the arithmetic mean roughness Ra of the surface 511 of the base material 51 is equal to or greater than 2.5 and equal to or less than 25. The reason is that, when the above-mentioned ratio is smaller than 2.5, the film thickness decreases with respect to the roughness of the surface 511, and an effect of the roughness of the surface 511 becomes excessive, and a texture of the hour hand 5 becomes too rough. Further, the reason is that, when the above-mentioned ratio is greater than 25, the film thickness increases with respect to the roughness of the surface 511, and an effect of the roughness of the surface 511 becomes small, and a texture of the hour hand 5 becomes too shiny. In other words, by forming the base material 51 and the decorative film 52 such that the above-mentioned ratio is equal to or greater than 2.5 and equal to or less than 25, a shine can be moderately suppressed as a texture of the hour hand 5, and a sense of luxury can be acquired.

Color Absorption Film

The color absorption film 521 is disposed on the surface 511 side of the base material 51, and is constituted by a film containing nitride, carbide, or metal. Examples of nitride constituting the color absorption film 521 preferably include TiN, CrN, and the like, and examples of carbide preferably include TiC, CrC, and the like. Further, examples of metal constituting the color absorption film 521 preferably include Ag, Pt, Au, Cu, Al, Cr, Sn, Fe, Ti, and the like, an alloy thereof, and the like.

The color absorption film 521 provides a metallic feeling, and adjusts the brightness. When the color absorption film 521 is constituted by TiN, a gold appearance having a sense of luxury can be acquired as the hour hand 5.

Furthermore, when the color absorption film 521 is constituted by TiC, an appearance tinged with black having a sense of luxury can be acquired as the hour hand 5.

Note that a method for forming the color absorption film 521 is not particularly limited, and examples thereof include ion assisted deposition, ion plating deposition, vacuum deposition, sputtering, and the like.

Further, a thickness of the color absorption film 521 is preferably equal to or greater than 0.03 μm, and is more preferably equal to or greater than 0.04 μm. Furthermore, the color absorption film 521 may be constituted by a single layer or a plurality of layers. When the color absorption film 521 is constituted by a plurality of layers, an oxide layer 5221 described later may be disposed between the plurality of layers.

Color Adjustment Film

The color adjustment film 522 is disposed on the surface 511 side of the base material 51. In the present exemplary embodiment, the color absorption film 521 and the color adjustment film 522 are laminated in this order on the surface 511 of the base material 51. In other words, the color absorption film 521 is disposed between the surface 511 of the base material 51 and the color adjustment film 522. The color adjustment film 522 adjusts a color tone by optical interference.

Further, the color adjustment film 522 is constituted by a multilayer film including an inorganic oxide film. In other words, the color adjustment film 522 is constituted as a laminated body including the plurality of oxide layers 5221.

The oxide layer 5221 may be constituted by an oxide of an inorganic material, but is preferably constituted by a material including at least one type selected from a group consisting of Ta₂O₅, SiO₂, TiO₂, Al₂O₃, ZrO₂, Nb₂O₅, and HfO₂.

Further, the plurality of oxide layers 5221 are more preferably constituted as layers constituted by materials different from each other being selected from the above-mentioned group. In this way, a degree of freedom in color adjustment that can be expressed as the hour hand 5 can be increased. Further, the oxide mentioned above is a material having high chemical stability, and can increase stability and durability of an appearance as the hour hand 5.

Note that a method for forming each of the oxide layers 5221 is not particularly limited, and examples thereof include ion assisted deposition, ion plating deposition, vacuum deposition, sputtering, and the like.

Further, the oxide layer 5221 is preferably two or more layers, and is more preferably three or more layers.

Advantageous Effects of First Exemplary Embodiment

According to the present exemplary embodiment, the following advantageous effects can be produced.

In the present exemplary embodiment, the hour hand 5 that is a watch component includes the base material 51 and the decorative film 52. An arithmetical mean roughness Ra of the surface 511 of the base material 51 on which the decorative film 52 is disposed is equal to or greater than 0.02 μm and equal to or less than 0.1 μm, and a film thickness of the decorative film 52 is equal to or greater than 0.25 μm and equal to or less than 1.0 μm. Then, a ratio of the film thickness of the decorative film 52 to the arithmetic mean roughness Ra of the surface 511 is equal to or greater than 2.5 and equal to or less than 25.

In this way, a shine can be moderately suppressed as a texture of the hour hand 5, and a sense of luxury can be acquired.

In the present exemplary embodiment, the color absorption film 521 and the color adjustment film 522 are laminated in this order on the surface 511 of the base material 51. In this way, for example, an adhesive layer and the like are not formed between the surface 511 and the color absorption film 521, and thus a step of forming the decorative film 52 can be simplified.

In the present exemplary embodiment, a material for the base material 51 is formed of a material containing metal, resin, or glass. In this way, strength of the hour hand 5 can be increased by forming the base material 51 from metal such as iron and brass, for example. Further, for example, while a weight of the hour hand 5 is reduced by forming the base material 51 from resin, a sense of luxury can be acquired as a texture.

In the present exemplary embodiment, the color absorption film 521 is constituted by a film containing nitride, carbide, or metal. The nitride is preferably TiN or CrN, the carbide is preferably TiC or CrC, and the metal is preferably

Ag, Pt, Au, Cu, Al, Cr, Sn, Fe, Ti, or an alloy thereof. In this way, an appearance having a sense of luxury can be acquired as the hour hand 5.

In the present exemplary embodiment, the color adjustment film 522 is constituted by the plurality of oxide layers 5221 including an inorganic oxide film. Then, the oxide layer 5221 is constituted by a material including at least one type selected from a group consisting of Ta₂O₅, SiO₂, TiO₂, Al₂O₃, ZrO₂, Nb₂O₅, and HfO₂. In this way, a range of a color tone that can be expressed as the hour hand 5 can be further widened. Furthermore, these inorganic oxides have high chemical stability, and can thus increase stability and durability of an appearance as the hour hand 5.

Second Exemplary Embodiment

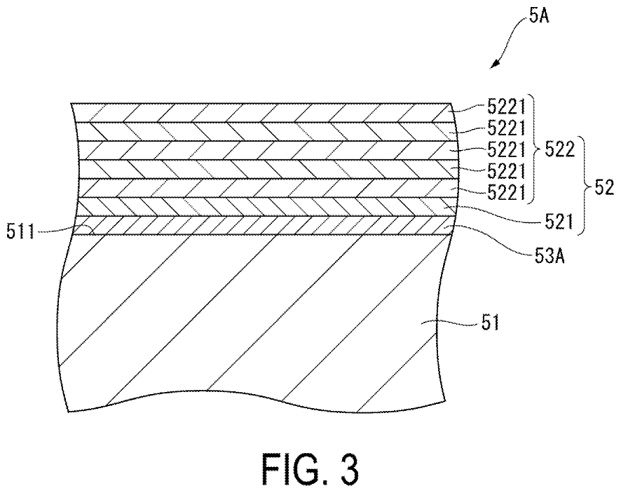

Now, a second exemplary embodiment of the present disclosure will be described with reference to FIG. 3. The second exemplary embodiment is different from the first exemplary embodiment described above in that an adhesive layer 53A is disposed between a surface 511 of a base material 51 and a color absorption film 521.

Note that, in the second exemplary embodiment, the same or similar components as or to those of the first exemplary embodiment will be given the same reference numerals and detailed description will be omitted or simplified.

FIG. 3 is an enlarged cross-sectional view illustrating a main part of an hour hand 5A according to the second exemplary embodiment.

As illustrated in FIG. 3, the hour hand 5A in the present exemplary embodiment includes the base material 51, a decorative film 52, and the adhesive layer 53A.

The adhesive layer 53A is disposed between the surface 511 of the base material 51 and the color absorption film 521 of the decorative film 52. The adhesive layer 53A is constituted by SiO₂, Cr, or the like, for example, and improves adhesion between the surface 511 of the base material 51 and the color absorption film 521.

Note that a method for forming the adhesive layer 53A is not particularly limited, and examples thereof include ion assisted deposition, ion plating deposition, vacuum deposition, sputtering, and the like.

Advantageous Effects of Second Exemplary Embodiment

According to the present exemplary embodiment, the following advantageous effects can be produced.

In the present exemplary embodiment, the adhesive layer 53A disposed between the surface 511 of the base material 51 and the color absorption film 521 is provided. In this way, peeling of the decorative film 52 from the base material 51 can be suppressed, and durability of the hour hand 5A can be improved.

Next, specific examples will be described.

### EXAMPLE 1

A method for manufacturing an hour hand as a watch component in Example 1 will be described.

First, a plate material made of brass was stamped to manufacture a base material having a shape of an hour hand. Then, a hole was formed by crimping a part of the base material.

Next, the base material was washed. As washing of the base material, first, alkaline electrolytic degreasing was performed for 30 seconds, then neutralization was performed for 10 seconds, washing with water was performed for 10 seconds, and washing with pure water was performed for 10 seconds.

Next, the base material was subjected to Ni plating, and surface treatment was performed on a surface of the base material. Specifically, wet blasting was performed by using an alumina material as an abrasive material. As a result, an arithmetic mean roughness Ra of the surface was 0.025 μm.

Next, a decorative film was formed on the surface of the base material by ion assisted deposition, and the hour hand was manufactured. Specifically, a Cr layer having a thickness of 0.080 μm in a first layer and a Cr layer having a thickness of 0.007 μm in a third layer were laminated as a color absorption film on the surface side of the base material. Then, an Al₂O₃ layer having a thickness of 0.090 μm in a second layer, a SiO₂ layer having a thickness of 0.011 μm in a fourth layer, an Al₂O₃ layer having a thickness of 0.100 μm in a fifth layer, and a SiO₂ layer having a thickness of 0.070 μm in a sixth layer were laminated in order as a color adjustment film. In other words, the decorative film of 0.358 μm was laminated on the base material.

Note that, in Example 1, a ratio of the film thickness of the decorative film to the arithmetic mean roughness Ra of the surface of the base material was 14.3.

### EXAMPLE 2

Similarly to Example 1 described above, a base material was manufactured by processing a brass plate material, and the base material was subjected to Ni plating. Then, wet blasting was performed on the base material. In Example 2, an arithmetic mean roughness Ra of a surface was 0.091 μm.

Then, the same decorative film as that in Example 1 was formed on the surface of the base material, and an hour hand was manufactured.

Note that, in Example 2, a ratio of the film thickness of the decorative film to the arithmetic mean roughness Ra of the surface of the base material was 3.9.

### EXAMPLE 3

Similarly to Examples 1 and 2 described above, a base material was manufactured by processing a brass plate material, and the base material was subjected to Ni plating. Then, wet blasting was performed on the base material. In Example 3, an arithmetic mean roughness Ra of a surface was 0.098 μm.

Next, a decorative film was formed on the surface of the base material by ion assisted deposition, and an hour hand was manufactured. Specifically, a Cr layer having a thickness of 0.050 μm in a first layer, a Cr layer having a thickness of 0.028 μm in a third layer, and a Cr layer having a thickness of 0.009 μm in a sixth layer were laminated as a color absorption film on the surface side of the base material. Then, a TiO₂ layer having a thickness of 0.183 μm in a second layer, an Al₂O₃ layer having a thickness of 0.056 μm in a fourth layer, a TiO₂ layer having a thickness of 0.009 μm in a fifth layer, an Al₂O₃ layer having a thickness of 0.021 μm in a seventh layer, and a SiO₂ layer having a thickness of 0.066 μm in an eighth layer were laminated in order as a color adjustment film on the color absorption layer. In other words, the decorative film of 0.422 μm was laminated on the base material.

Note that, in Example 3, a ratio of the film thickness of the decorative film to the arithmetic mean roughness Ra of the surface of the base material was 4.3.

### COMPARATIVE EXAMPLE 1

A method for manufacturing an hour hand as a watch component in Comparative Example 1 will be described.

Similarly to Examples 1 to 3 described above, a base material was manufactured by processing a brass plate material, and the base material was subjected to Ni plating. Here, in Comparative Example 1, surface treatment such as wet blasting was not performed on a surface of the base material. Thus, in Comparative Example 1, an arithmetic mean roughness Ra of the surface of the base material was 0.009 μm. In other words, the surface of the base material in Comparative Example 1 was generally a mirror surface.

Then, the same decorative film as that in Examples 1 and 2 was formed on the surface of the base material, and an hour hand was manufactured.

Note that, in Comparative Example 1, a ratio of the film thickness of the decorative film to the arithmetic mean roughness Ra of the surface of the base material was 39.8.

### COMPARATIVE EXAMPLE 2

Similarly to Examples 1 to 3 and Comparative Example 1 described above, a base material was manufactured by processing a brass plate material, and the base material was subjected to Ni plating. Then, wet blasting was performed on the base material. In Comparative Example 2, an arithmetic mean roughness Ra of a surface was 0.226 μm.

Then, the same decorative film as that in Examples 1 and 2 and Comparative Example 1 was formed on the surface of the base material, and an hour hand was manufactured.

Note that, in Comparative Example 2, a ratio of the film thickness of the decorative film to the arithmetic mean roughness Ra of the surface of the base material was 1.6.

Evaluation Test

The following evaluation tests were performed on the hour hand in Examples 1 to 3 and Comparative Examples 1 and 2 described above.

Texture Test

A visual test was performed on the hour hand in Examples 1 to 3 and Comparative Examples 1 and 2 to evaluate a texture.

As an evaluation criteria, “A” was used when a sense of luxury can be acquired while moderately suppressing a shine, “B” was used when roughness of the surface was prominent with an excessively low gloss, and “C” was used when a shine was excessive and glare was strong.

Color Tone Observation

A visual test was performed on the hour hand in Examples 1 to 3 and Comparative Examples 1 and 2, and a color tone was observed.

Texture Test Result

As shown in Table 1, the hour hand in Examples 1 to 3 was “A” as a texture test result, indicating that a sense of luxury can be acquired while moderately suppressing a shine. On the other hand, the hour hand in Comparative Example 1 was “C”, indicating that a shine was excessive and glare was strong, and the hour hand in Comparative Example 2 was “B”, indicating that roughness of the surface was prominent with an excessively low gloss.

From the results, it was suggested that a texture of the hour hand can be improved and a sense of luxury can be acquired when the arithmetical mean roughness Ra of the surface of the base material was equal to or greater than 0.02 μm and equal to or less than 0.1 μm, a film thickness of the decorative film was equal to or greater than 0.25 μm and equal to or less than 1.0 μm, and, furthermore, a ratio of the film thickness of the decorative film to the arithmetic mean roughness Ra of the surface of the base material is equal to or greater than 2.5 and equal to or less than 25.

Color Tone Observation Result

As shown in Table 1, a color tone of the hour hand in Examples 1 and 2 and Comparative Examples 1 and 2 was blue.

Further, a color tone of the hour hand in Example 3 was black. The color tones were generated by optical interference between the layers of the color absorption film and the color adjustment film. The color tone can be changed by changing a material and a film thickness of each of the films.

TABLE 1

| | TEST CONDITION | | | | | |
|---|---|---|---|---|---|---|
| | | SURFACE | FILM | FILM | TEST RESULT | |
| | ROUGHNESS | ROUGHNESS Ra | THICKNESS | THICKNESS/ | | COLOR |
| | TREATMENT | μm | μm | Ra | TEXTURE | TONE |
| EXAMPLE 1 | WET | 0.025 | 0.358 | 14.3 | A | BLUE |
| | BLASTING | | | | | |
| EXAMPLE 2 | WET | 0.091 | 0.358 | 3.9 | A | BLUE |
| | BLASTING | | | | | |
| EXAMPLE 3 | WET | 0.098 | 0.422 | 4.3 | A | BLACK |
| | BLASTING | | | | | |
| COMPARATIVE | NONE | 0.009 | 0.358 | 39.8 | C | BLUE |
| EXAMPLE 1 | | | | | | |
| COMPARATIVE | WET | 0.226 | 0.358 | 1.6 | B | BLUE |
| EXAMPLE 2 | BLASTING | | | | | |

Modification Example

Note that the present disclosure is not limited to each of the exemplary embodiments described above, and variations, modifications, and the like within the scope in which the object of the present disclosure can be achieved are included in the present disclosure.

In each of the exemplary embodiments described above, the watch component of the present disclosure is constituted as the hour hands 5 and 5A, which is not limited thereto. For example, the watch component of the present disclosure may be constituted as a seconds hand, a minute hand, a dial, a dial ring, a component attached to a dial such as an hour mark, a bezel, a display plate, a case, a case back, a crown, a button, a windshield, a component constituting a movement, and the like.

Further, in each of the exemplary embodiments described above, the decorative film 52 is disposed so as to cover the entire surface 511 of the base material 51, which is not limited thereto. For example, the decorative film may be disposed only in a place that can be visually recognized by a user. Specifically, for example, when the watch component is a dial, the decorative film may be disposed only on a surface on a windshield side of the dial.

Furthermore, the watch of the present disclosure may include a plurality of watch components constituted as described above.

What is claimed is:

1. A watch component, comprising:
a base material including a surface having an arithmetical mean roughness Ra that is equal to or greater than 0.02 μm and equal to or less than 0.1 μm; and
a decorative film disposed at the surface and having a thickness equal to or greater than 0.25 μm and equal to or less than 1.0 μm and moreover including a color absorption film and a color adjustment film, wherein
a ratio of the film thickness of the decorative film to the arithmetical mean roughness Ra of the surface is equal to or greater than 2.5 and equal to or less than 25.

2. The watch component according to claim 1, wherein
at the surface the color absorption film of the decorative film is disposed between the surface of the base material and the color adjustment film.

3. The watch component according to claim 1, comprising an adhesive layer disposed between the decorative film and the surface.

4. The watch component according to claim 1, wherein
a material of the base material is metal, resin, or glass.

5. The watch component according to claim 2, wherein
a material of the base material is metal, resin, or glass.

6. The watch component according to claim 3, wherein
a material of the base material is metal, resin, or glass.

7. The watch component according to claim 1, wherein
the color absorption film is constituted of a film containing nitride, carbide, or metal.

8. The watch component according to claim 2, wherein
the color absorption film is constituted of a film containing nitride, carbide, or metal.

9. The watch component according to claim 3, wherein
the color absorption film is constituted of a film containing nitride, carbide, or metal.

10. The watch component according to claim 4, wherein
the color absorption film is constituted of a film containing nitride, carbide, or metal.

11. The watch component according to claim 7, wherein
the nitride is TiN or CrN,
the carbide is TiC or CrC, and
the metal is Ag, Pt, Au, Cu, Al, Cr, Sn, Fe, Ti, or an alloy thereof.

12. The watch component according to claim 8, wherein
the nitride is TiN or CrN,
the carbide is TiC or CrC, and
the metal is Ag, Pt, Au, Cu, Al, Cr, Sn, Fe, Ti, or an alloy thereof.

13. The watch component according to claim 9, wherein
the nitride is TiN or CrN,
the carbide is TiC or CrC, and
the metal is Ag, Pt, Au, Cu, Al, Cr, Sn, Fe, Ti, or an alloy thereof.

14. The watch component according to claim 1, wherein
the color adjustment film is constituted of a multilayer film including an inorganic oxide film.

15. The watch component according to claim 8, wherein
the color adjustment film is constituted of a multilayer film including an inorganic oxide film.

16. The watch component according to claim 9, wherein
the color adjustment film is constituted of a multilayer film including an inorganic oxide film.

17. The watch component according to claim 10, wherein
the color adjustment film is constituted of a multilayer film including an inorganic oxide film.

18. The watch component according to claim 11, wherein
the color adjustment film is constituted of a multilayer film including an inorganic oxide film.

19. The watch component according to claim 14, wherein
the multilayer film includes two or more oxide layers constituted of a material including at least one type selected from a group consisting of Ta₂O₅, SiO₂, TiO₂, Al₂O₃, ZrO₂, Nb₂O₅, and HfO₂.

20. A watch comprising the watch component according to claim 1.
